(19) United States
(12) Patent Application Publication
(10) Pub. No.: US 2017/0270795 A1
(43) Pub. Date: Sep. 21, 2017

(54) VEHICLE PARKING SYSTEM

(71) Applicant: ANAND VAIDYANATHAN, CHENNAI (IN)

(72) Inventor: ANAND VAIDYANATHAN, CHENNAI (IN)

(21) Appl. No.: 15/088,151

(22) Filed: Apr. 1, 2016

(30) Foreign Application Priority Data
Mar. 17, 2016 (IN) 201641009366

(51) Int. Cl. G08G 1/14; G06Q 50/26; G06Q 20/14; G06Q 10/02; G06Q 30/02

(52) U.S. Cl. CPC G08G 1/144; G06Q 10/02; G06Q 30/0284; G06Q 20/14; G06Q 50/26

(57) ABSTRACT

A parking system that identifies one or more unoccupied slots from one or more parking lots using a parking server is provided. The parking server includes information of one or more unoccupied slots, and one or more occupied slots. The parking system includes a user communication device that communicates a location/destination of the user to the parking server. The user communication device receives the one or more unoccupied slots associated with the location/destination of the user from the parking server. The user communication device displays the one or more unoccupied slots to the user to reserve a parking slot from the one or more unoccupied parking slots by (a) scanning (i) a QR code, (ii) a RFID, and (iii) a sound tag, or (b) entering a displayed text related to the parking slot.

### BACKGROUND

Technical Field

The embodiments herein generally relate to vehicle parking system, and, more particularly, system and method for parking and verifying user vehicle on parking slot in parking lot.

Description of the Related Art

Population is increasing day by day and the infrastructure of many large cities is under strain. Nowadays, most of the people have their own vehicle to make their travel easy and comfortable. As a result of which there has been a substantial increase in the traffic along with the requirement for more parking space. A city municipal corporation and/or some parking company employ parking stations in many places of cities to manage parking availability, wherein users are charged a fee which is generally related to the amount of time their vehicle is parked in a given parking area. The city municipal corporation or county has a number of methods by which they collect parking revenue including ‘pole parking meters’, central parking meters which have a pad to enter parking details and receive a receipt, boom barrier parking meters which issues tickets when you enter a designated parking area and collections are done when you to leave the area to even using parking attendants in counters where lab out costs are low.

Typically, the city municipal corporation and/or parking company install parking meter in each parking station. The parking meter is fed by the patron with vehicle details and required parking hours and shows an amount to be paid for parking. The parking meter accepts various payment modes such as cash payment and cashless payment from the users and issues the parking ticket. Upon expiry of the number of parking hours, the user have to extend the parking hours by again entering the vehicle details and the number of parking hours in the parking meters, otherwise the user may subject to receive a fine issued by a law enforcement officer or an attendant/in-charge of the parking stations. In another system there are ‘pole parking meters’ and the user has to insert coins into the parking meter associated with the parking spot taken to be allowed to park for a certain duration of time.

In some major cities, the city municipal or parking company launches a mobile parking system, wherein the user can make payment and occupy the parking slot by using their mobile phone. The mobile parking system is implemented in co-operation with the mobile phone service providers and third party billing vendor. The user needs to register and create an account in the third party billing vendor for using this mobile parking system. The user has to use an App to send their license plate number every time while parking. The implementation and execution of mobile parking system is cumbersome. Moreover such a system would be difficult to enforce as the officer enforcing parking payments would find it very difficult to correlate and match the list of number plates authorized to be parked at that time with the actual cars parked as they may be in any order and there could be a large number of cars parked at any given time. For example, if parking lot has 100 parking slots means, the enforcer needs to check 100 parking slots manually. This is a cumbersome and time consuming process. Further, when the user needs to park his vehicle, the user needs to look for free slots near his destination. Here the user needs to go to the parking lot and scan the code associated with parking slot to reserve the parking slot, and this is time consuming process. There is no system for reserving the parking slot from the user's location. Therefore, reserving and verifying the parking slot in parking lot is unsure and random process.

Accordingly, there remains a need for a system and method for identifying one or more unoccupied slots for parking a user vehicle, and/or verifying a user vehicle on the one or more unoccupied parking slots in an efficient and productive fashion.

### SUMMARY

In view of the foregoing, an embodiment herein provides a parking system that identifies one or more unoccupied slots from one or more parking lots using a parking server. The parking server includes a memory, and a processor. The memory stores a parking database, and a set of modules. The parking database stores information associated with a list of parking slots on the one or more parking lots. The information includes at least one of (i) a location of each of the list of parking slots in a parking lot, and (ii) a status of each of the list of parking slots. In one embodiment, the status indicates whether each of the list of parking slots are occupied or not. The processor executes the set of modules. The set of modules includes a user location information obtaining module, a plurality of unoccupied slots identification module, an unoccupied slots information communication module, and a user parking information receiving module. The user location information obtaining module is configured to obtain a destination of a user from a user communication device. The plurality of unoccupied slots identification module is configured to identify one or more unoccupied slots associated with the destination of the user from the one or more parking lot. The unoccupied slots information communication module is configured to communicate the one or more unoccupied slots associated with the destination of the user to the user communication device. The user parking information receiving module is configured to receive parking information related to occupancy of a parking slot selected from the one or more unoccupied slots from the user communication device when the user occupies the parking slot. In one embodiment, the parking information includes at least one of (i) a slot identification code, and a lot identification code associated with the parking slot, (ii) payment account information related to the user of the parking slot, and (iii) an anticipated parking duration.

In one embodiment, the location information obtaining module receives a voice based destination information that is determined based on a voice of the user from the user communication device. The plurality of unoccupied slots identification module identifies one or more unoccupied slots associated with the voice based destination information from the one or more parking lots. The unoccupied slots information communication module communicates the one or more unoccupied slots associated with the voice based destination information to the user communication device.

In one embodiment, the parking server includes a billing module that is configured to calculate an amount for parking a user's vehicle on the parking slot based on the parking duration and parking rates. In one embodiment, the parking rates are obtained from rate cards that are previously stored in the billing module by parking authorities. In another embodiment, the parking rates are subjected to change based on (i) at least one of a time of the day, a day of the week, location of lot, a calendar date in a year, and a duration of parking, and (ii) a real time increase in the occupancy of the lots.

In one embodiment, the user communication device includes a user location information communicating module, an unoccupied slots information receiving module, an unoccupied slots mapping module, a parking reservation module, a user parking information communication module, and a parking timer module. The user location information communicating module is configured to communicate the destination of the user to the parking server. The unoccupied slots information receiving module is configured to receive the one or more unoccupied slots associated with the destination of the user from the parking server. The unoccupied slots mapping module is configured to display the one or more unoccupied slots that are identified from the one or more parking lots along with a location of the one or more unoccupied parking slots in a map. The parking reservation module is configured to reserve a parking slot from the one or more unoccupied parking slots by (a) scanning at least one of (i) a QR code, (ii) a RFID, and (iii) a sound tag associated with the parking slot, or (b) entering a displayed text related to the parking slot associated with the plurality of parking lot. The user parking information communication module is configured to communicate parking information related to occupancy of the parking slot selected to the parking server when the user occupies the parking slot. In one embodiment, the parking information includes at least one of (i) the slot identification code, and the lot identification code associated the parking slot, (ii) the payment account information related to the user of the parking slot, and (iii) the parking duration. In another embodiment, the parking duration includes at least one of (i) a time block basis of anticipated parking duration of the user vehicle in the parking slot, and (ii) a duration permit authorizing the user to park the user vehicle in the parking slot. The parking timer module is configured to apprise a parking time to the user communication device for existing parking of the user vehicle in the parking slot. In one embodiment, the parking timer module provides options to the user to (a) start a timer which is started when the user parks the user vehicle in the parking slot and (b) stop the timer which is activated when the user exits the user vehicle from the parking slot. In another embodiment, the parking time includes at least one of (i) the parking duration of the user vehicle, and (ii) an additional time extension for parking the user vehicle.

In one embodiment, the user location information communicating module communicates the voice based destination of the user to the parking server. In another embodiment, the unoccupied slots information receiving module receives the one or more unoccupied slots associated with the voice based destination information to the user communication device. In yet another embodiment, the unoccupied slots mapping module displays the one or more unoccupied slots that are identified based on the voice based destination information along with a location of the one or more unoccupied parking slots in the map. In one embodiment, the user communication device further includes an alert communication module. The alert communication module is configured to notify an alert message that indicates an expiration of the parking duration to the user communication device. In one embodiment, the user communication device provides options to select a monthly pass based on at least one of (i) the destination of the user, and (ii) the voice based destination, obtained from the user communication device

In one aspect, an embodiment herein provides a parking verification system that verifies one or more parking slots on a parking lot using a parking verification server. The parking verification server includes a memory, and a processor. The memory stores a parking verification database and a set of modules. In one embodiment, the parking verification database stores information associated a list of parking slots on the parking lot. In one embodiment, the information includes at least one (i) a location of each of the one or more parking slots, and (ii) a status of each of the one or more parking slots. In one embodiment, the status indicates whether each of the one or more parking slots are occupied or not. The processor executes the set of modules. The set of modules includes an enforcer location information obtaining module, a plurality of unoccupied parking slots identification module, a plurality of unoccupied parking slots information communication module, and a ticket information receiving module. The enforcer location information obtaining module is configured to obtain a location of an enforcer from an enforcer communication device. The plurality of unoccupied parking slots identification module is configured to identify one or more unoccupied parking slots associated with the location of the enforcer from the parking lot.

The plurality of unoccupied parking slots information communication module is configured to communicate the one or more unoccupied parking slots associated with the location of the enforcer to the enforcer communication device. The ticket information receiving module is configured to receive a ticket information related to occupancy of a parking slot selected from the one or more unoccupied parking slots from the enforcer communication device when a violator occupies the parking slot. In one embodiment, the ticket information includes at least one of (i) a slot identification code, and a lot identification code associated with occupancy of the parking slot, (ii) payment account information related of occupancy of the parking slot, (iii) a parking duration, (iv) an image of a violator parking vehicle associated with the violator, and (iv) a parking ticket associated with occupancy of the parking slot, (v) a license plate number, (vii) a GPS stamp related to a location of the violator parking vehicle, (viii) a time and date stamp related to the ticket information that is obtained from the enforcer communication device. In another embodiment, the GPS stamp is generated automatically when the image of the violator parking vehicle is obtained.

In one embodiment, the enforcer communication device includes an enforcer location information communicating module, a plurality of parking slots information receiving module, an unoccupied parking slots mapping module, a violator parking vehicle image obtaining module, a parking ticket raising module, and a parking verification information communication module. The enforcer location information communicating module is configured to communicate the location of the enforcer to the parking verification server. The plurality of parking slots information receiving module is configured to receive the one or more unoccupied parking slots associated with the location of the enforcer from the parking verification server. The unoccupied parking slots mapping module is configured to display the one or more unoccupied parking slots that are identified from the parking lot along with a location of the one or more unoccupied parking slots, in a map. In one embodiment, the map displays one or more occupied slots using a monthly pass or parking sticker. The violator parking vehicle image obtaining module is configured to obtain the image of the violator parking vehicle associated with the violator that occupies the parking slot. In one embodiment, the image further includes at least one of (i) the license plate number, (ii) the image of the violator parking vehicle associated with the violator, (iii) the GPS stamp that is related to location of the vehicle is parked which generates automatically when the image obtains, (viii) the time and date stamp that is related to the ticket which obtains from the enforcer communication device of the enforcer. The parking ticket raising module is configured to raise the parking ticket against the violator parking vehicle along with the image. The parking verification information communication module is configured to communicate the verification information related to occupancy of the parking slot selected from the one or more unoccupied slots to the parking verification server when the user occupies the parking slot.

In another aspect, a method for identifying one or more unoccupied slots from one or more parking lots using a parking server. The method includes the following steps: (i) storing, at the parking server, information associated with a list of parking slots on the one or more parking lots; (ii) obtaining, by the parking server, a location/destination of a user from an user communication device; (iii) identifying, by the parking server, a one or more unoccupied slots associated with the location/destination of the user from the one or more parking lots; (iv) communicating, by the parking server, the one or more unoccupied slots associated with the location/destination of the user to the user communication device; and (v) displaying, at the user communication device, the one or more unoccupied slots that are identified from the one or more parking lots along with a location of the one or more unoccupied parking slots in a map. In one embodiment, the information associated with the list of parking slots includes at least one of (i) a location of each of the list of parking slots, and (ii) a status of each of the list of parking slots. In another embodiment, the status indicates whether each of the list of parking slots are occupied or not,

The method further includes the following steps: (A) reserving, using the user communication device, a parking slot selected from the one or more unoccupied parking slots from the one or more of lots by (a) scanning at least one of (i) a QR code, (ii) a RFID, and (iii) a sound tag associated with the parking slot, or (b) entering a displayed text related to the parking slot associated with the one or more parking lot; and (B) receiving, by the parking server, parking information related to occupancy of the parking slot from the user communication device when the user occupies the parking slot. In one embodiment, the parking information includes at least one of (i) occupancy details of the parking slot, (ii) a payment information related of occupancy of the parking slot, and (iii) a parking duration.

In one embodiment, the method further includes the following steps: (C) receiving, by the parking server, the voice based destination information that is determined based on a voice of the user from the user communication device, (ii) identifying, by the parking server, one or more unoccupied slots associated with the voice based destination information from the one or more parking lots: (D) communicating, by the parking server, the one or more unoccupied slots associated with the voice based destination information to the user communication device: and (E) displaying, at the user communicating device, the one or more unoccupied slots that are identified based on the voice based destination information along with a location of the one or more unoccupied parking slots in the map. In another embodiment, the method further includes the step of: (F) notifying, by the parking server, an alert message that indicates an expiration of the parking duration to the user communication device.

In one embodiment, the user is an enforcer. When the user is the enforcer, the method further includes the following steps; (G) obtaining, using the user communication device, an image of a violator parking vehicle associated with a violator that occupies a parking slot from the one or more unoccupied parking slots; (H) raising, using the user communication device, a parking ticket against the violator parking vehicle along with the image; (I) communicating, using the user communication device, ticket information related to occupancy of the parking slot selected from the one or more unoccupied slots to parking server when the violator occupies the parking slot; and (J) receiving, by the parking server, the ticket information related to occupancy of the parking slot selected from the one or more unoccupied slots to parking server when the violator occupies the parking slot that is listed as unoccupied. In one embodiment, the ticket information includes at least one of (i) a slot identification code, and a lot identification code associated with occupancy of the parking slot, (ii) payment account information related of occupancy of the parking slot, (iii) a parking duration, (iv) an image of a violator parking vehicle associated with the violator, and (iv) a parking ticket associated with occupancy of the parking slot, (v) the license plate number, (vii) the GPS stamp related to a location of the violator parking vehicle, (viii) the time and date stamp related to the ticket information that is obtained from the enforcer communication device. In another embodiment, the GPS stamp is generated automatically when the image of the violator parking vehicle is obtained. In yet another embodiment, the image of the violator parking vehicle includes at least one of (i) the license plate number, (ii) the GPS stamp related to a location of the violator parking vehicle, and (iii) the time and date stamp related to the ticket information that is obtained from the enforcer communication device.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of a user interacting with a vehicle parking system to identify one or more unoccupied slots from one or more parking lots according to an embodiment herein;

FIG. 2 illustrates an exploded view of the parking server of FIG. 1 according to an embodiment herein;

FIG. 3 illustrates an exploded view of the user communicating device of FIG. 1 according to an embodiment herein;

FIG. 4 illustrates a system view of an enforcer interacting with a parking verification system to verify one or more unoccupied parking slots on a parking lot according to an embodiment herein;

FIG. 5 illustrates an exploded view of the parking verification server of FIG. 4 according to an embodiment herein;

FIG. 6 illustrates an exploded view of the enforcer communication device of FIG. 4 according to an embodiment herein;

FIG. 7 illustrates a user interface view of the parking system 100 that displays one or more unoccupied slots on the user communication device based on the location of the user of FIG. 1 according to an embodiment herein;

FIG. 8 is a flow diagram illustrating a method for identifying one or more unoccupied slots from one or more parking lots using a parking server 108 of FIG. 1 according to an embodiment herein;

FIG. 9 illustrates an exploded view of a user/enforcer communication device according to the embodiments herein; and

FIG. 10 a schematic diagram of computer architecture used in accordance with the embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

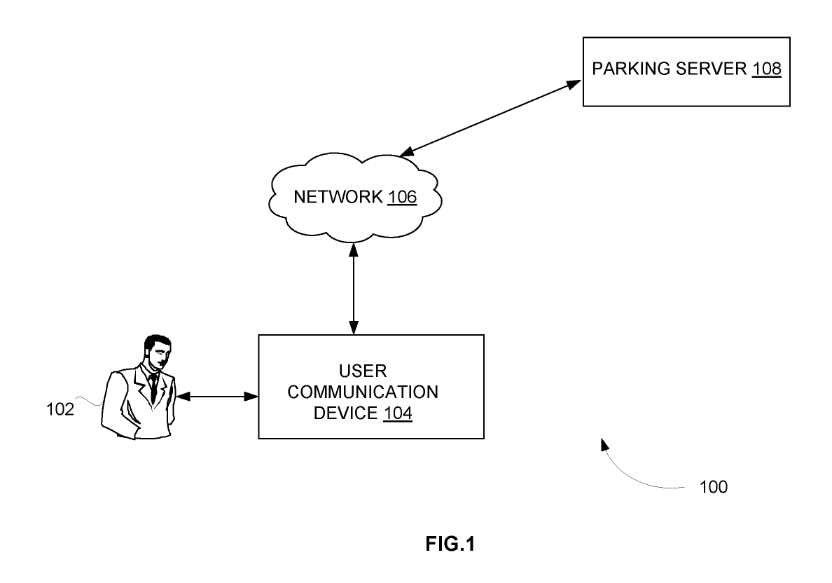

As mentioned, there remains a need for a system and method for identifying one or more unoccupied slots for parking and/or verifying user vehicle on the parking slots in an efficient and productive fashion. The embodiments herein achieve this, by providing a parking system that identifies and communicates one or more unoccupied slots from one or more parking lot to a user communication device through a parking server for reserving/verifying the one or more unoccupied slots. Referring now to the drawings, and more particularly to FIG. 1 through FIG. 10, where similar reference characters denote corresponding features consistently throughout the figures, there are shown preferred embodiments.

FIG. 1 illustrates a system view 100 of a user interacting with a vehicle parking system to identify one or more unoccupied slots from one or more parking lots according to an embodiment herein. The vehicle parking system includes a user 102, a user communication device 104, a network 106, and a parking server 108. The parking server 108 includes information of one or more unoccupied slots, and one or more occupied slots. The user communication device 104 communicates a location/destination of the user 102 to the parking server through the network 108. The user communication device 104 receives the one or more unoccupied slots associated with the location/destination of the user 102 from the parking server 108. The user communication device 104 displays the one or more unoccupied slots to the user 102 to reserve a parking slot from the one or more unoccupied parking slots by (a) scanning at least one of (i) a QR code, (ii) a RFID, and (iii) a sound tag associated with the parking slot, or (b) entering a displayed text related to the parking slot associated with one or more parking lot. The user communication device 104 may include, but it is not limited to a personal computer (PC), a mobile communication device, a smart phone, a tablet PC, a laptop, a desktop, an ultra-book, any other network device capable of connecting to the network 106 for operational purposes. In one embodiment, the network 108 may include, but not limited to, an internet, intranet, a wide area network, a wired cable network, a broadcasting network, a wired communication network, a wireless communication network, a fixed wireless network, a mobile wireless network, and the like.

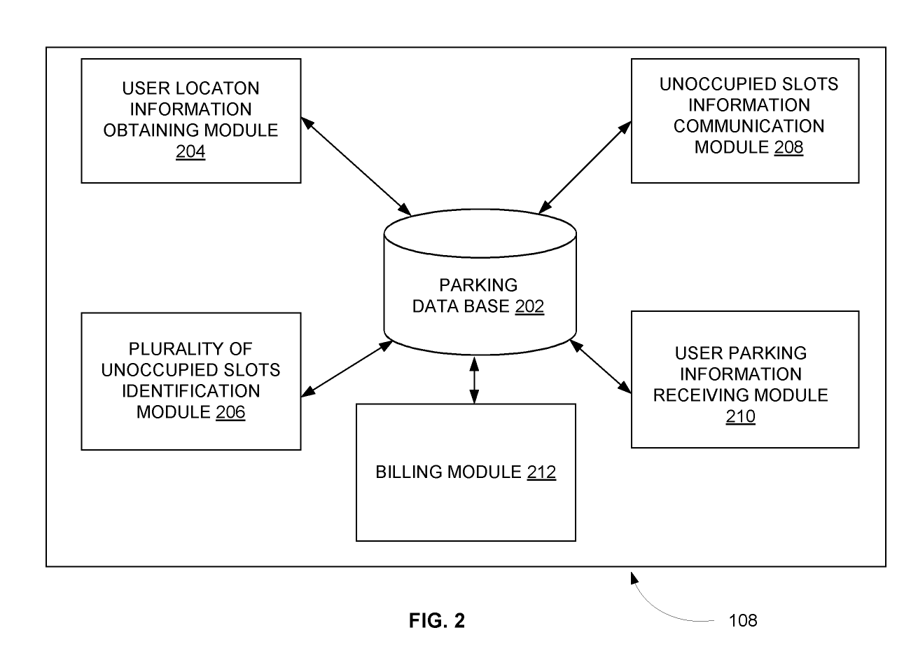

FIG. 2 illustrates an exploded view of the parking server 108 of FIG. 1 according to an embodiment herein. The parking server 108 includes a parking database 202, a user location information obtaining module 204, a plurality of unoccupied slots identification module 206, an unoccupied slots information communication module 208, a user parking information receiving module 210, and a billing module 212. The parking database 202 is configured to store information associated with a list of parking slots on the one or more parking lots. In one embodiment, the information associated with a list of parking slots includes at least one of (i) a location of each of the list of parking slots, and (ii) a status of each of the list of parking slots. The status indicates whether each of the list of parking slots are occupied or not. The user location information obtaining module 204 is configured to obtain a location of the user from the user communication device 104. In one embodiment, the location information obtaining module 204 receives a voice based destination information that is determined based on a voice of the user 102 from the user communication device 104.

The plurality of unoccupied slots identification module 206 is configured to identify one or more unoccupied slots associated with the location/destination of the user 102 from the one or more parking lots. In one embodiment, the plurality of unoccupied slots identification module 206 identifies the one or more unoccupied slots associated with the voice based destination information from the one or more parking lots. The unoccupied slots information communication module 208 is configured to communicate the one or more unoccupied slots associated with the location/destination of the user 102 to the user communication device 104. In one embodiment, the unoccupied slots information communication module 208 communicates the one or more unoccupied slots associated with the voice based destination information to the user communication device 104. The user parking information receiving module 210 is configured to receive parking information related to occupancy of a parking slot selected from the one or more unoccupied slots from the user communication device 104 when the user 102 occupies the parking slot.

In one embodiment, the parking information includes at least one of (i) a slot identification code, and a lot identification code associated with the parking slot, (ii) payment account information related to the user of the parking slot, and (iii) a parking duration. The billing module 212 is configured to calculate an amount for parking a user's vehicle on the parking slot based on the parking duration and parking rates. In one embodiment, the parking rates are obtained from rate cards that are previously stored in the billing module 212 by parking authorities. In another embodiment, the parking rates are subjected to change based on (i) at least one of a time of the day, a day of the week, a location of lot, a calendar date in a year, and a duration of parking, and (ii) real time increase in the occupancy of said plurality of lots.

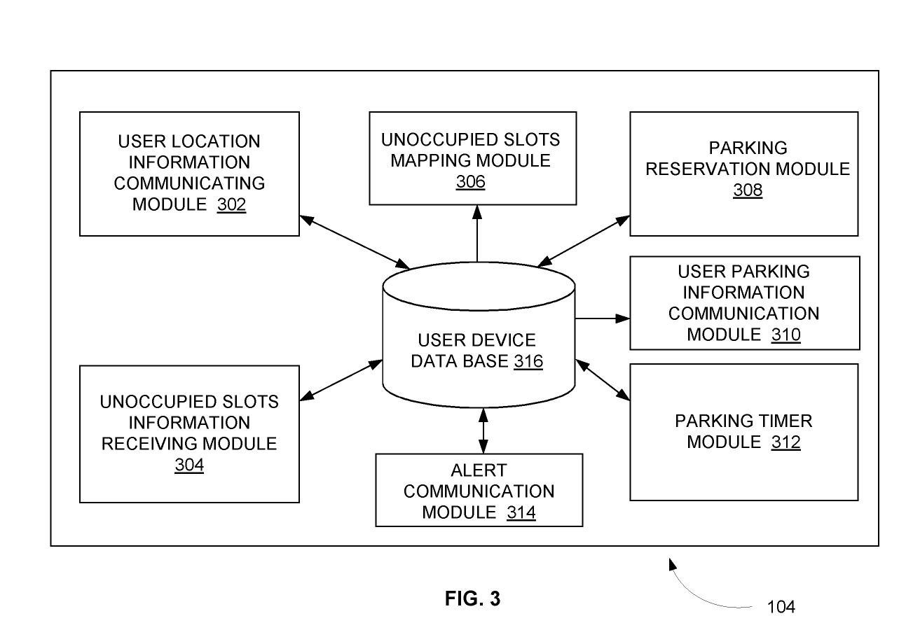

With reference to FIG. 2, FIG. 3 illustrates an exploded view of the user communicating device 104 of FIG. 1 according to an embodiment herein. The user communicating device 104 includes a user location information communicating module 302, an unoccupied slots information receiving module 304, an unoccupied slots mapping module 306, a parking reservation module 308, a user parking information communication module 310, a parking timer module 312, an alert communication module 314, and a user device database 316. The user location information communicating module 302 is configured to communicate the location/destination of the user 102 to the parking server 108. In one embodiment, the user location information communicating module 302 communicates the voice based location/destination of the user 102 to the parking server 108. The unoccupied slots information receiving module 304 is configured to receive the one or more unoccupied slots associated with the location/destination of the user 102 from the parking server 108.

In one embodiment, the unoccupied slots information receiving module 304 receives the one or more unoccupied slots associated with the voice based destination information to the user communication device 104. The unoccupied slots mapping module 306 is configured to display the one or more unoccupied slots that are identified from the one or more parking lots along with a location of the one or more unoccupied parking slots in a map. In one embodiment, the unoccupied slots mapping module 306 displays the one or more unoccupied slots that are identified based on the voice based destination information along with a location of the one or more unoccupied parking slots in the map. The parking reservation module 308 is configured to reserve a parking slot from the one or more unoccupied parking slots by (a) scanning at least one of (i) a QR code, (ii) a RFID, and (iii) a sound tag associated with the parking slot, or (b) entering a displayed text related to the parking slot associated with the one or more parking lot.

The user parking information communication module 310 is configured to communicate parking information related to occupancy of the parking slot selected to the parking server when the user 102 occupies the parking slot. In one embodiment, the parking information includes at least one of (i) the slot identification code, and the lot identification code associated the parking slot, (ii) the payment account information related to the user 102 of the parking slot, and (iii) the parking duration. In another embodiment, the parking duration includes at least one of (i) a time block basis of anticipated parking duration of the user vehicle is the parking slot, and (ii) a duration permit authorizing said user 102 to park the user vehicle in the parking slot. The parking timer module 312 is configured to apprise a parking time to the user communication device 104 for existing parking of the user vehicle in the parking slot.

In one embodiment, the parking timer module 312 provides options to the user to (a) start a timer which is started when the user 102 parks the user vehicle in the parking slot and (b) stop the timer which is activated when the user 102 exits the user vehicle from the parking slot. In another embodiment, the parking time includes at least one of (i) the parking duration of the user vehicle, and (ii) an additional time extension for parking the user vehicle. In one embodiment, the user communication device 104 provides options to select a monthly pass based on at least one of (i) the location/destination of the user, and (ii) the voice based destination, obtained from the user communication device 104.

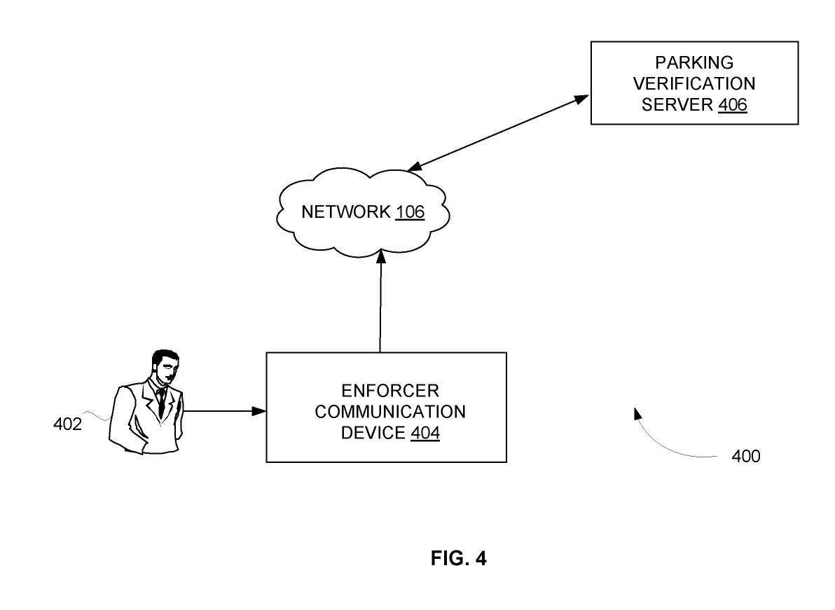

FIG. 4 illustrates a system view 400 of an enforcer interacting with a parking verification system to verify one or more unoccupied parking slots on a parking lot according to an embodiment herein. The parking verification system 400 includes an enforcer 402, an enforcer communication device 404, the network 108, and a parking verification server 406. A location of the enforcer 402 is communicated to the parking verification server 406 using the enforcer communication device 404 through the network 108. The enforcer communication device 404 receives one or more unoccupied parking slots associated with the location of enforcer 404 from the parking verification server 406. In one embodiment, the enforcer 402 raises a parking ticket against a violator when the violator occupies the parking slot which is listed as unoccupied slot in the parking verification server 406. The enforcer communication device 404 provides options to the enforcer 402 to check only the one or more unoccupied slots, and raise a ticket for the vehicles that are parked in the one or more unoccupied slots.

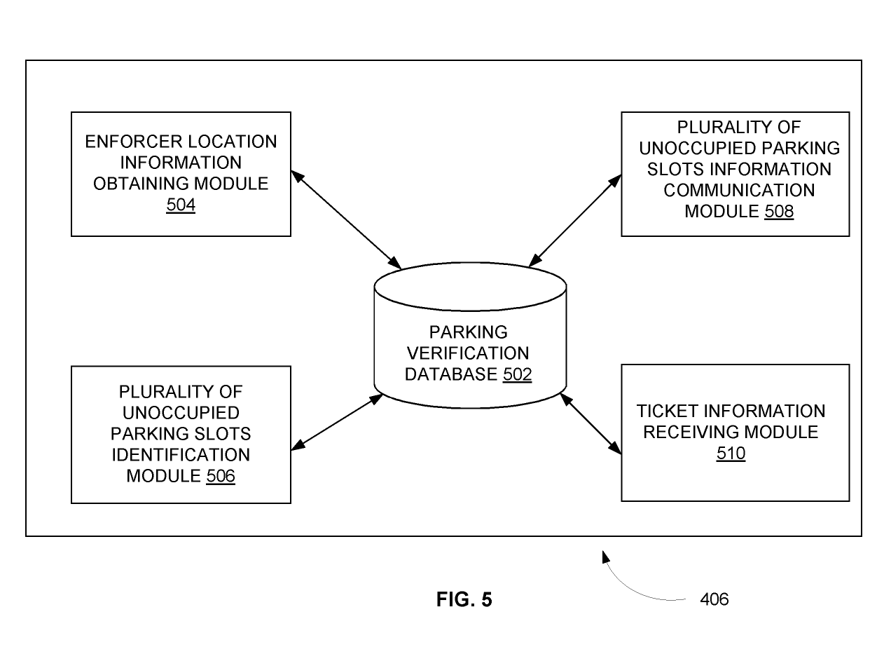

FIG. 5 illustrates an exploded view of the parking verification server 406 of FIG. 4 according to an embodiment herein. The parking verification server 406 includes a parking verification database 502, an enforcer location information obtaining module 504, a plurality of unoccupied parking slots identification module 506, a plurality of unoccupied parking slots information communication module 508, and a ticket information receiving module 510. The parking verification database 502 stores information associated a list of parking slots on the parking lots. In one embodiment, the information includes at least one (i) a location of each of the one or more parking slots in the parking lots, and (ii) a status of each of the one or more of parking slots. In another embodiment, the status indicates whether each of the one of more parking slots are occupied or not. The enforcer location information obtaining module 504 is configured to obtain a location of the enforcer 402 from the enforcer communication device 404. The plurality of unoccupied parking slots identification module 506 is configured to identify the one or more unoccupied parking slots associated with the location of the enforcer 402.

The plurality of unoccupied parking slots information communication module 508 is configured to communicate the one or more unoccupied parking slots associated with the location of the enforcer 402 to the enforcer communication device 404. The ticket information receiving module 510 is configured to receive a ticket information related to occupancy of the parking slot selected from the one or more unoccupied parking slots from the enforcer communication device 404 when the violator occupies the parking slot. In one embodiment, the ticket information includes at least one of (i) a slot identification code, and a lot identification code associated with occupancy of the parking slot, (ii) payment account information related of occupancy of the parking slot, (iii) a parking duration, (iv) an image of a violator parking vehicle associated with the violator, and (iv) the parking ticket associated with occupancy of the parking slot, (v) a license plate number, (vii) a GPS stamp related to a location of the violator parking vehicle, (viii) a time and date stamp related to the ticket information that is obtained from the enforcer communication device 404. In another embodiment, the GPS stamp is generated automatically when the image of the violator parking vehicle is obtained.

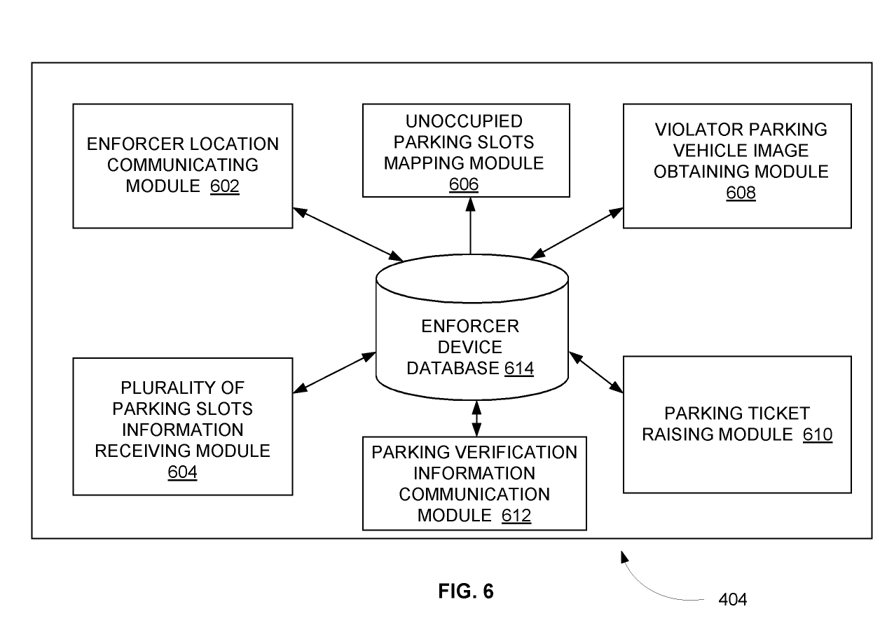

With reference to FIG. 5, FIG. 6 illustrates an exploded view of the enforcer communication device 404 of FIG. 4 according to an embodiment herein. The enforcer communication device 404 includes an enforcer location information communicating module 602, a plurality of parking slots information receiving module 604, an unoccupied parking slots mapping module 606, a violator parking vehicle image obtaining module 608, a parking ticket raising module 610, a parking verification information communication module 612 and an enforcer device database 614. The enforcer location information communicating module 602 is configured to communicate a location of the enforcer 402 to the parking verification server 406. The plurality of parking slots information receiving module 604 is configured to receive the one or more unoccupied parking slots associated with the location of the enforcer 402 from the parking verification server. The unoccupied parking slots mapping module 606 is configured to display the one or more unoccupied parking slots that are identified from the parking lot along with the location of the one or more unoccupied parking slots, in a map.

In one embodiment, the map displays one or more occupied slots using a monthly pass or parking sticker. The violator parking vehicle image obtaining module 608 is configured to obtain the image of the violator parking vehicle associated with the violator that occupies the parking slot. In one embodiment, the image further includes at least one of (i) the license plate number, (ii) the image of the violator parking vehicle associated with the violator, (iii) the GPS stamp that is related to location of the vehicle is parked which generates automatically when the image obtains, (viii) the time and date stamp that is related to the ticket which obtains from the enforcer communication device 404 of the enforcer 402. The parking ticket raising module 610 is configured to raise the parking ticket against the violator parking vehicle along with the image. The parking verification information communication module 612 is configured to communicate the verification information related to occupancy of the parking slot selected from one or more unoccupied slots to the parking verification server 406 when the user 102 occupies the parking slot.

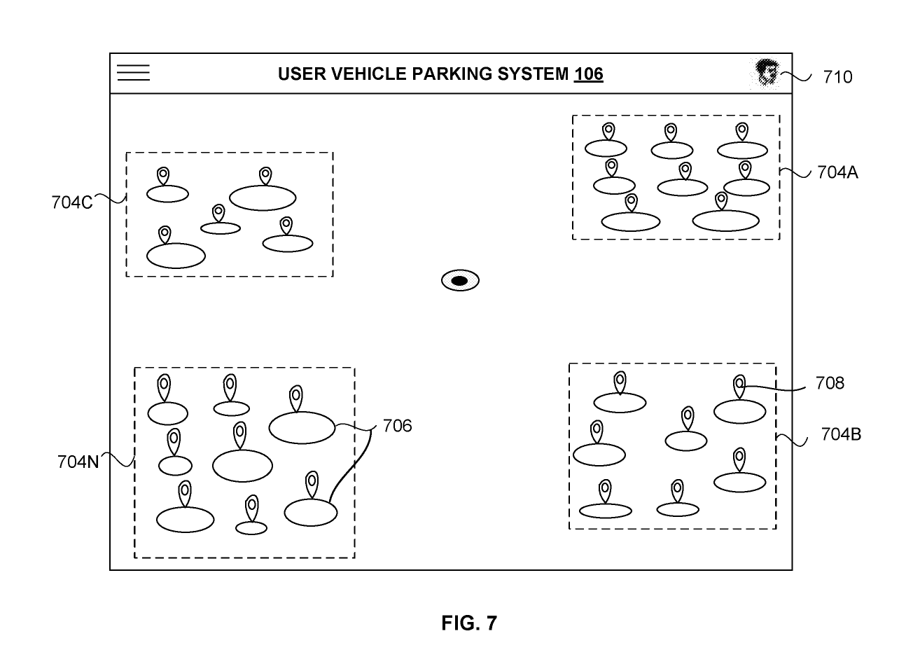

FIG. 7 illustrates a user interface view 700 of the parking system 100 that displays one or more unoccupied slots on the user communication device 104 based on the location of the user 102 of FIG. 1 according to an embodiment herein. The user interface view includes a location of the user vehicle 702, the one or more parking lots 704A-N, one or more unoccupied slot 708 in each of the one or more parking lots 704A-N, a geo tag 706 for each of the unoccupied slot 708, and a profile 710 of the user 102. The user communication device 104 displays the one or more unoccupied slots 708 related to each the one or more parking lots 704A-N along with a location of the one or more unoccupied parking slots 708 in a map. In one embodiment, each of the one or more unoccupied slots 708 includes the geo tag 706. The geo tag includes a location the parking slot.

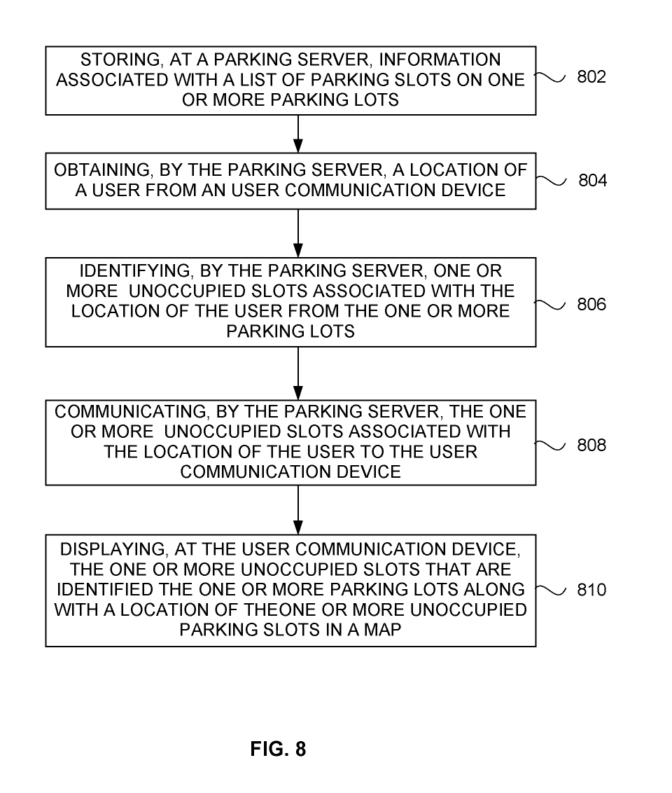

FIG. 8 is a flow diagram illustrating a method for identifying one or more unoccupied slots from one or more parking lots using a parking server 108 of FIG. 1 according to an embodiment herein. At step 802, the parking server 108 stores information associated with a list of parking slots on the one or more parking lots 704A-N. In one embodiment, the information includes at least one of (i) a location of each of the list of parking slots on the one or more parking lots 704A-N, and (ii) a status of each of the list of parking slots. In another embodiment, the status indicates whether each of the list of parking slots are occupied or not. At step 804, the parking server 108 obtains a location of the user 102 from the user communication device 104. At step 806, the parking server 104 identifies one or more unoccupied slots 708 associated with the location of the user 102 from the one or more parking lots 704A-N. At step 808, the parking server 108 communicates the one or more unoccupied slots 708 associated with the location of the user 102 to the user communication device 104. At step 810, the user communication device 104 displays the one or more unoccupied slots 706 that are identified from the one or more parking lots 704A-N along with a location of the one or more unoccupied parking slots 708 in a map.

In one embodiment, the method further includes following steps: (A) reserving, using the user communication device 104, a parking slot selected from the one or more unoccupied parking slots 708 by (a) scanning at least one of (i) the QR code, (ii) the RFID, and (iii) the sound tag associated with the parking slot, or (b) entering the displayed text related to the parking slot associated with the one or more parking lot; and (B) receiving, by the parking server 108, parking information related to occupancy of the parking slot from the user communication device 104 when the user occupies the parking slot. In one embodiment, the parking information includes at least one of (i) occupancy details of the parking slot, (ii) the payment information related of occupancy of the parking slot, and (iii) the parking duration. In one embodiment, the method further includes following steps: (C) receiving, by the parking server 108, the voice based destination information that is determined based on a voice of the user 102 from the user communication device 104; (D) identifying, by the parking server 108, the one or more unoccupied slots 708 associated with the voice based destination information from the one or more parking lots; (E) communicating, by the parking server 108, the one or more unoccupied slots 708 associated with the voice based destination information to the user communication device 104; (F) displaying, at the user communicating device 104, the one or more unoccupied slots that are identified based on the voice based destination information along with a location of the one or more unoccupied parking slots 708 in the map; and (G) notifying, by the parking server 108, an alert message that indicates an expiration of the parking duration to the user communication device 104.

In another embodiment, when the user 102 is the enforcer 402, the method further includes following steps: (H) obtaining, using the user communication device 104, an image of a violator parking vehicle associated with a violator that occupies a parking slot from the one or more unoccupied parking slots 708; (I) raising, using the user communication device 104, a parking ticket against the violator parking vehicle along with the image; (J) communicating, using the user communication device 104, ticket information related to occupancy of the parking slot selected from the one or more unoccupied slots 708 to parking server when the violator occupies the parking slot; and (K) receiving, by the parking server 108, the ticket information related to occupancy of the parking slot selected from the one or more unoccupied slots 708 to parking server when the violator occupies the parking slot. In one embodiment, the image related to the violator parking vehicle includes at least one of (i) a license plate number, (ii) a GPS stamp related to a location of the violator parking vehicle, and (iii) a time and date stamp related to the ticket information that is obtained from the enforcer communication device 404. In another embodiment, the GPS stamp is generated automatically when the image of the violator parking vehicle is obtained. In yet another embodiment, the ticket information includes at least one of (i) a slot identification code, and a lot identification code associated with occupancy of the parking slot, (ii) payment account information related of occupancy of the parking slot, (iii) a parking duration, (iv) an image of a violator parking vehicle associated with the violator, and (iv) a parking ticket associated with occupancy of the parking slot, (v) the license plate number, (vii) the GPS stamp related to a location of the violator parking vehicle, (viii) the time and date stamp related to the ticket information that is obtained from the enforcer communication device 404.

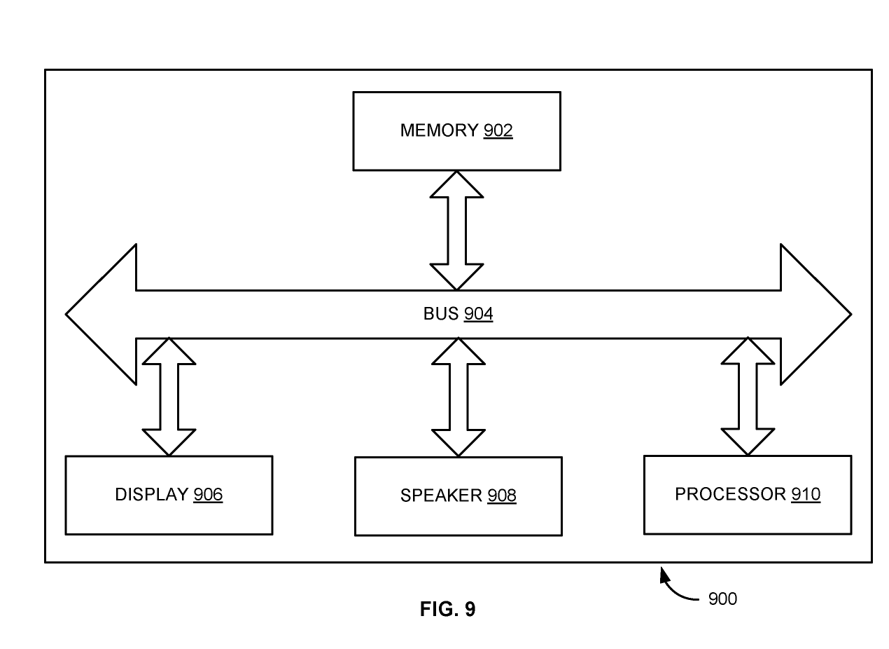

FIG. 9 illustrates an exploded view of the user/personal communication device having an a memory 902 having a set of computer instructions, a bus 904, a display 906, a speaker 908, and a processor 910 capable of processing a set of instructions to perform any one or more of the methodologies herein, according to an embodiment herein. In one embodiment, the receiver may be the personal communication device. The processor 910 may also enable digital content to be consumed in the form of video for output via one or more displays 906 or audio for output via speaker and/or earphones 908. The processor 910 may also carry out the methods described herein and in accordance with the embodiments herein.

Digital content may also be stored in the memory 902 for future processing or consumption. The memory 902 may also store program specific information and/or service information (PSI/SI), including information about digital content (e.g., the detected information bits) available in the future or stored from the past. A user of the personal communication device may view this stored information on display 906 and select an item of for viewing, listening, or other uses via input, which may take the form of keypad, scroll, or other input device(s) or combinations thereof. When digital content is selected, the processor 910 may pass information. The content and PSI/SI may be passed among functions within the personal communication device using the bus 904.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

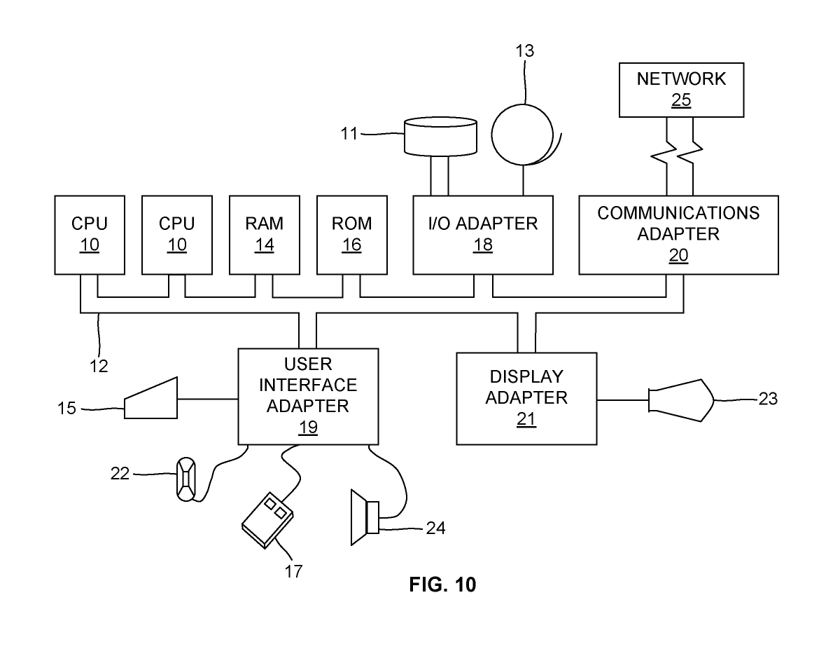

A representative hardware environment for practicing the embodiments herein is depicted in FIG. 10. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, other program storage devices that are readable by the system. The system can read the inventive instructions on the program storage devices and follow these instructions to execute the methodology of the embodiments herein.

The system further includes a user interface adapter 19 that may connects to a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The parking system 100 is easy to use and implement. The parking system 100 provides easy way to obtain and reserve an unoccupied slots for the user 102. The parking system 100 provides options to the enforcer 402 to check only the one or more unoccupied slots, and raise a ticket for the vehicles that are parked in the one or more unoccupied slots.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A vehicle parking system that identifies a plurality of unoccupied slots from a plurality of parking lots using a parking server 108, said parking server 108 comprising:
a memory that stores a parking database 202 and a set of modules, wherein said parking database 202 stores information associated with a list of parking slots on said plurality of parking lots, wherein said information comprises at least one of (i) a location of each of said list of parking slots in said plurality of parking lots, and (ii) a status of each of said list of parking slots, wherein said status indicates whether each of said list of parking slots are occupied or not; and
a processor that executes said set of modules, wherein said set of modules comprises
a user location information obtaining module 204 that is configured to obtain a destination of a user 102 from an user communication device 104;
a plurality of unoccupied slots identification module 206 that is configured to identify a plurality of unoccupied slots associated with said destination of said user 102 from said plurality of parking lot;
an unoccupied slots information communication module 208 that is configured to communicate said plurality of unoccupied slots associated with said destination of said user 102 to said user communication device 104; and
a user parking information receiving module 210 that is configured to receive parking information related to occupancy of a parking slot selected from said plurality of unoccupied slots from said user communication device 104 when said user 102 occupies said parking slot, wherein said parking information comprises at least one of (i) a slot identification code, and a lot identification code associated with said parking slot, (ii) payment account information related to said user 102 of said parking slot, and (iii) an anticipated parking duration.

2. The parking system as claimed in claim 1, wherein said location information obtaining module 204 receives a voice based destination information that is determined based on a voice of said user 102 from said user communication device 104, wherein said plurality of unoccupied slots identification module 206 identifies a plurality of unoccupied slots associated with said voice based destination information from said plurality of parking lots, wherein said unoccupied slots information communication module 208 communicates said plurality of unoccupied slots associated with said voice based destination information to said user communication device 104.

3. The parking system as claimed in claim 1, wherein said parking server comprises a billing module 212 that is configured to calculate an amount for parking a user vehicle 702 on said parking slot based on said parking duration and parking rates, wherein said parking rates are obtained from rate cards that are previously stored in said billing module 212 by parking authorities, wherein said parking rates are subjected to change based on (i) at least one of a time of the day, a day of the week, a location of said plurality of lots, a calendar date in a year, and a duration of parking, or (ii) a real time increase in the occupancy of said plurality of lots.

4. The parking system as claimed in claim 3, wherein said user communication device comprises:
a user location information communicating module 302 that is configured to communicate said destination of said user 102 to said parking server 108;
an unoccupied slots information receiving module 304 that is configured to receive said plurality of unoccupied slots associated with said destination of said user 102 from said parking server 108;
an unoccupied slots mapping module 306 that is configured to display said plurality of unoccupied slots that are identified from said plurality of parking lots along with a location of said plurality of unoccupied parking slots in a map;
a parking reservation module 308 that is configured to reserve a parking slot from said plurality of unoccupied parking slots by (a) scanning at least one of (i) a QR code, (ii) a RFID, and (iii) a sound tag associated with said parking slot, or (b) entering a displayed text related to said parking slot associated with said plurality of parking lot;
a user parking information communication module 310 that is configured to communicate parking information related to occupancy of said parking slot selected to said parking server 108 when said user 102 occupies said parking slot, wherein said parking information comprises at least one of (i) said slot identification code, and said lot identification code associated said parking slot, (ii) said payment account information related to said user of said parking slot, and (iii) said parking duration, wherein said parking duration comprises at least one of (i) a time block basis of anticipated parking duration of said user vehicle 702 in said parking slot, and (ii) a duration permit authorizing said user 102 to park said user vehicle 702 in said parking slot; and
a parking timer module 312 that is configured to apprise a parking time to said user communication device 104 for existing parking of said user vehicle 702 in said parking slot, wherein said parking timer module 312 provides options to said user 102 to (a) start a timer which is started when said user 102 parks said user vehicle 702 in said parking slot and (b) stop said timer which is activated when said user 102 exits said user vehicle 702 from said parking slot, wherein said parking time comprises at least one of (i) said parking duration of said user vehicle 702, and (ii) an additional time extension for parking said user vehicle 702.

5. The parking system as claimed in claim 4, wherein said user location information communicating module 302 communicates said voice based destination of said user 102 to said parking server 108, wherein said unoccupied slots information receiving module 304 receives said plurality of unoccupied slots associated with said voice based destination information to said user communication device 104, wherein said unoccupied slots mapping module 306 displays said plurality of unoccupied slots that are identified based on said voice based destination information along with a location of said plurality of unoccupied parking slots in said map.

6. The parking system as claimed in claim 5, wherein said user communication device 104 further comprises
an alert communication module 314 that is configured to notify an alert message that indicates an expiration of said parking duration to said user communication device 104.

7. The parking system as claimed in claim 6, wherein said user communication device 104 provides options to select a monthly pass based on at least one of (i) said destination of said user 102, and (ii) said voice based destination, obtained from said user communication device 104.

8. A parking verification system that verifies a plurality of parking slots on a parking lot using a parking verification server 406, said parking verification server 406 comprising:
a memory that stores a parking verification database 502 and a set of modules, wherein said parking verification database stores information associated a list of parking slots on said parking lot, wherein said information comprises at least one (i) a location of each of said plurality of parking slots, and (ii) a status of each of said plurality of parking slots, wherein said status indicates whether each of said plurality of parking slots are occupied or not; and
a processor that executes said set of modules, wherein said set of modules comprises
an enforcer location information obtaining module 504 that is configured to obtain a location of an enforcer 402 from an enforcer communication device 404;
a plurality of unoccupied parking slots identification module 506 that is configured to identify a plurality of unoccupied parking slots associated with said location of said enforcer 402 from said parking lot;
a plurality of unoccupied parking slots information communication module 508 that is configured to communicate said plurality of unoccupied parking slots associated with said location of said enforcer 402 to said enforcer communication device 406; and
a ticket information receiving module 510 that is configured to receive a ticket information related to occupancy of a parking slot selected from said plurality of unoccupied parking slots from said enforcer communication device 404 when a violator occupies said parking slot, wherein said ticket information comprises at least one of (i) a slot identification code, and a lot identification code associated with occupancy of said parking slot, (ii) payment account information related of occupancy of said parking slot, (iii) a parking duration, (iv) an image of a violator parking vehicle associated with said violator, and (iv) a parking ticket associated with occupancy of said parking slot, (v) a license plate number, (vii) a GPS stamp related to a location of said violator parking vehicle, (viii) a time and date stamp related to said ticket information that is obtained from said enforcer communication device 404, wherein said GPS stamp is generated automatically when said image of said violator parking vehicle is obtained.

9. The system as claimed in claim 8, wherein said enforcer communication device 404 comprises
an enforcer location information communicating module 602 that is configured to communicate said location of said enforcer 402 to said parking verification server 406;
a plurality of parking slots information receiving module 604 that is configured to receive said plurality of unoccupied parking slots associated with said location of said enforcer 402 from said parking verification server 406;
an unoccupied parking slots mapping module 606 that is configured to display said plurality of unoccupied parking slots that are identified from said parking lot along with a location of said plurality of unoccupied parking slots, in a map, wherein said map displays one or more occupied slots using a monthly pass or parking sticker;
a violator parking vehicle image obtaining module 608 that is configured to obtain said image of said violator parking vehicle associated with said violator that occupies said parking slot, wherein said image further comprises at least one of (i) said license plate number, (ii) said image of said violator parking vehicle associated with said violator, (iii) said GPS stamp that is related to location of said vehicle is parked which generates automatically when said image obtains, (viii) said time and date stamp that is related to said ticket which obtains from said enforcer communication device 404 of said enforcer 402;
a parking ticket raising module 610 that is configured to raise said parking ticket against said violator parking vehicle along with said image; and
a parking verification information communication module 612 that is configured to communicate said verification information related to occupancy of said parking slot selected from said plurality of unoccupied slots to said parking verification server 406 when said user 102 occupies said parking slot.

10. A method for identifying a plurality of unoccupied slots from a plurality of parking lots using a parking server 108, said method comprising:
storing, at said parking server 108, information associated with a list of parking slots on said plurality of parking lots, wherein said information comprises at least one of (i) a location of each of said list of parking slots in said plurality of parking lots, and (ii) a status of each of said list of parking slots, wherein said status indicates whether each of said list of parking slots are occupied or not;
obtaining, by said parking server 108, a location/destination of a user 102 from an user communication device 104;
identifying, by said parking server 108, a plurality of unoccupied slots associated with said location/destination of said user 102 from said plurality of parking lots;
communicating, by said parking server, said plurality of unoccupied slots associated with said location/destination of said user 102 to said user communication device 104; and
displaying, at said user communication device 104, said plurality of unoccupied slots that are identified from said plurality of parking lots along with a location of said plurality of unoccupied parking slots in a map.

11. The method as claimed in claim 10, further comprising:
reserving, using said user communication device 104, a parking slot selected from said plurality of unoccupied parking slots from said plurality of lots by (a) scanning at least one of (i) a QR code, (ii) a RFID, and (iii) a sound tag associated with said parking slot, or (b) entering a displayed text related to said parking slot associated with said plurality of parking lot;
receiving, by said parking server 108, parking information related to occupancy of said parking slot from said user communication device 104 when said user 102 occupies said parking slot, wherein said parking information comprises at least one of (i) occupancy details of said parking slot, (ii) an payment information related of occupancy of said parking slot, and (iii) a parking duration.

12. The method as claimed in claim 11, wherein said method further comprises
receiving, by said parking server 108, a voice based destination information that is determined based on a voice of said user 102 from said user communication device 104;
identifying, by said parking server 108, a plurality of unoccupied slots associated with said voice based destination information from said plurality of parking lots;
communicating, by said parking server, said plurality of unoccupied slots associated with said voice based destination information to said user communication device 104, and
displaying, at said user communicating device 104, said plurality of unoccupied slots that are identified based on said voice based destination information along with a location of said plurality of unoccupied parking slots in said map.

13. The method as claimed in claim 12, said method further comprising the step of notifying, by said parking server 108, an alert message that indicates an expiration of said parking duration to said user communication device 104.

14. The method as claimed in claim 13, wherein said user 102 is an enforcer 402.

15. The method as claimed in claim 14, said method further comprising:
obtaining, using said user communication device 104, an image of a violator parking vehicle associated with a violator that occupies a parking slot from said plurality of unoccupied parking slots, wherein said image related to at least one of (i) a license plate number, (ii) a GPS stamp related to a location of said violator parking vehicle, and (iii) a time and date stamp related to said ticket information that is obtained from said enforcer communication device, wherein said GPS stamp is generated automatically when said image of said violator parking vehicle is obtained;
raising, using said user communication device 104, a parking ticket against said violator parking vehicle along with said image;
communicating, using said user communication device 104, ticket information related to occupancy of said parking slot selected from said plurality of unoccupied slots to said parking server 108 when said violator occupies said parking slot, wherein said ticket information comprises at least one of (i) a slot identification code, and a lot identification code associated with occupancy of said parking slot, (ii) payment account information related of occupancy of said parking slot, (iii) a parking duration, (iv) an image of a violator parking vehicle associated with said violator, and (iv) a parking ticket associated with occupancy of said parking slot, (v) said license plate number, (vii) said GPS stamp related to a location of said violator parking vehicle, (viii) said time and date stamp related to said ticket information that is obtained from said enforcer communication device 404, wherein said GPS stamp is generated automatically when said image of said violator parking vehicle is obtained; and
receiving, by said parking server 108, said ticket information related to occupancy of said parking slot selected from said plurality of unoccupied slots to parking server when said violator occupies said parking slot that is listed as unoccupied.
